(19) United States
(12) Patent Application Publication
(10) Pub. No.: US 2015/0168180 A1
(43) Pub. Date: Jun. 18, 2015

(54) OPTICAL ENCODER HAVING STATIONARY SLIT PART MADE OF RESIN

(71) Applicant: FANUC CORPORATION, Minamitsuru-gun (JP)

(72) Inventors: Miaomiao Wang, Yamanashi (JP); Shunichi Odaka, Yamanashi (JP); Mitsuyuki Taniguchi, Minamitsuru-gun (JP)

(73) Assignee: FANUC CORPORATION, Minamitsuru-gun (JP)

(21) Appl. No.: 14/567,325

(22) Filed: Dec. 11, 2014

(30) Foreign Application Priority Data
Dec. 16, 2013 (JP) 2013-259496

(51) Int. Cl. G01D 5/34

(52) U.S. Cl. CPC G01D 5/34

(57) ABSTRACT

An optical encoder includes a light emitting part for emitting light, a stationary slit part and a rotational slit part which allow part of the light emitted from the light emitting part to pass therethrough, and a light receiving part for detecting the light passing through the stationary slit part and the rotational slit part, in which the stationary slit part is made of resin. The optical encoder also includes a support for supporting the stationary slit part, and the stationary slit part is fixed to the support by adhesive.

### BACKGROUND OF THE INVENTION

1. Field of the Invention

The present invention relates to an optical encoder including a stationary slit part.

2. Description of the Related Art

An optical encoder is used to detect information on a rotatable element in rotational motion, such as a position, velocity, acceleration, or the like. The information detected by the optical encoder is used to control a servo motor provided at a drive shaft of a machine tool, for example.

The optical encoder includes a stationary slit part and a rotational slit part which allow part of light emitted from a light source to pass therethrough. JP-A-2005-274479 discloses a known optical encoder.

Conventionally, a stationary slit part is often made of glass. However, since the stationary slit part is fixed to a base formed on a stator of an electric motor, vibrating or impactive force may be transferred to and affect the stationary slit part through the stator and the base. Thus, the stationary slit part made of glass is easily damaged, and as a result, reliability of the optical encoder tends to be poor. In particular, a sharp corner of the stationary slit part is easily damaged by vibrating or impactive force acting thereon. In addition, a due care must be taken when the stationary slit part made of glass is transported and assembled, and therefore handling of the stationary slit part is inconvenient. Further, since glass is expensive and difficult to machine, the manufacturing cost tends to increase.

Accordingly, there is a need for a highly reliable optical encoder which prevents a stationary slit part from being damaged.

### SUMMARY OF THE INVENTION

According to a first aspect, an optical encoder comprising: a light emitting part for emitting light; a stationary slit part and a rotational slit part which allow part of the light emitted from the light emitting part to pass therethrough; and a light receiving part for detecting the light passing through the stationary slit part and the rotational slit part, wherein the stationary slit part is made of resin, is provided.

According to a second aspect, the optical encoder according to the first aspect further comprises a support for supporting the stationary slit part, wherein the stationary slit part is fixed to the support by adhesive.

According to a third aspect, in the optical encoder according to the second aspect, the stationary slit part includes a through hole extending between a first face facing the support and a second face on an opposite side of the first face, and the stationary slit part is fixed to the support by adhesive filled within the through hole.

According to a fourth aspect, in the optical encoder according to the third aspect, the through hole has cross-section area on the first face different from cross-section area on the second face.

According to a fifth aspect, in the optical encoder according to the third or fourth aspect, the through hole is slanted relative to a direction perpendicular to the first face and the second face.

These and other objects, features and advantages of the present invention will become more apparent in light of the detailed description of exemplary embodiments thereof as illustrated by the drawings.

### BRIEF DESCRIPTION OF THE DRAWINGS

FIG. 1A is a top view illustrating a stationary slit part of an optical encoder according to a first embodiment;

FIG. 1B is a front view illustrating the stationary slit part of FIG. 1A;

FIG. 2A is a top view illustrating a stationary slit part of an optical encoder according to a second embodiment;

FIG. 2B is a section view taken along dashed line 2B-2B of FIG. 2A;

FIG. 3A is a top view illustrating a stationary slit part of an optical encoder according to a third embodiment;

FIG. 3B is a section view taken along dashed line 3B-3B of FIG. 3A;

FIG. 4A is a top view illustrating a stationary slit part of an optical encoder according to a fourth embodiment;

FIG. 4B is a section view taken along dashed line 4B-4B of FIG. 4A;

FIG. 5A is a top view illustrating a stationary slit part of an optical encoder according to a fifth embodiment;

FIG. 5B is a section view taken along dashed line 5B-5B of FIG. 5A;

FIG. 6A is a top view illustrating a stationary slit part of an optical encoder according to a sixth embodiment;

FIG. 6B is a section view taken along dashed line 6B-6B of FIG. 6A; and

FIG. 7 is a perspective view schematically illustrating an exemplary configuration of an optical encoder to which the present invention can be applied.

### DETAILED DESCRIPTION OF THE INVENTION

Embodiments of the present invention will be described with reference to the accompanying drawings. The illustrated constituent elements may be modified in size in relation to one another as necessary for better understanding of the invention.

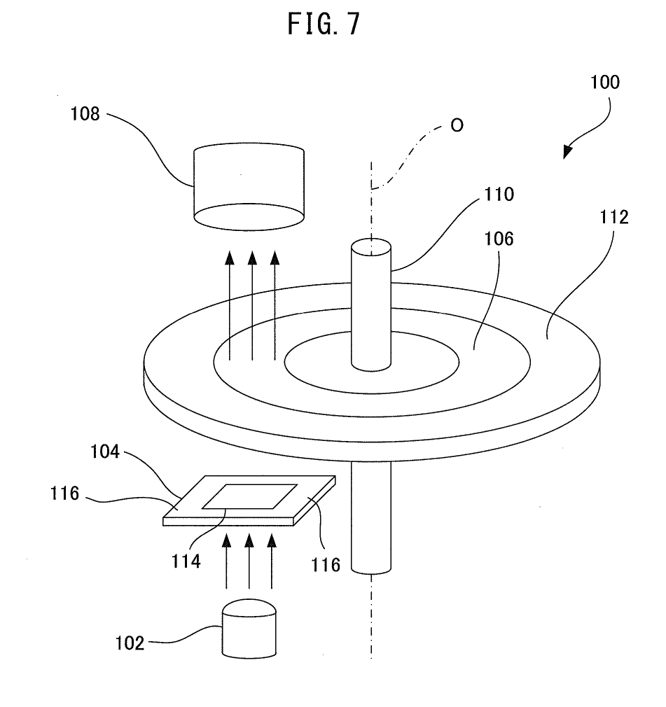

FIG. 7 is a perspective view schematically illustrating an exemplary configuration of an optical encoder to which the present invention can be applied. An optical encoder 100 includes a light emitting part 102 for emitting light, a stationary slit part 104 and a rotational slit part 106 which allow part of the light emitted from the light emitting part 102 to pass therethrough, and a light receiving part 108 for detecting the light passing through the stationary slit part 104 and the rotational slit part 106.

The light emitting part 102 serves as a light source for emitting light toward the stationary slit part 104 and the rotational slit part 106, as shown by arrows. The light emitting part 102 may be a light emitting diode (LED) or laser diode (LD), for example. The light emitting part 102 may include a lens for converting light into parallel light. The light emitted from the light emitting part 102 may have a wavelength in the range from infrared light to visible light.

The light receiving part 108 may be a phototransistor or photodiode. The light receiving part 108 have a detection range and sensitivity corresponding to a wavelength of the light emitted from the light emitting part 102. Although the light emitting part 102 and the light receiving part 108 are provided so as to be opposite to each other in the illustrated example, the light emitting part 102 and the light receiving part 108 may be optically coupled to each other via an optical waveguide such as an optical fiber.

The rotational slit part 106 is formed on a rotational disk 112 which rotates together with a rotational shaft 110 in rotational motion around a rotational axis line O. The rotational slit part 106 includes a plurality of slits arranged in accordance with a certain pattern.

The stationary slit part 104 is a substantially plate member attached via a support to a housing or a bracket (not shown) or the like, which is a fixed structure irrespectively of rotational motion of the rotational shaft 110 and the rotational disk 112. The stationary slit part 104 includes a patterned portion 114 formed with a plurality of slits through which light can pass, and a fixed portion 116 fixed to a support, which is not shown in FIG. 7. The detailed configuration of the stationary slit part 104 will be described below.

The stationary slit part 104 and the rotational slit part 106 cooperate with each other and allow the light emitted from the light emitting part 102 to pass therethrough, so as to form an image of light-and-dark pattern on the light receiving part 108. The light receiving part 108 detects the light-and-dark pattern and in response outputs an electric signal. In this way, the information such as a rotational position, velocity and acceleration of the rotational disk 112 and therefore those of the rotational shaft 110 can be detected.

The configuration of the optical encoder has been described with reference to FIG. 7 by way of example only. The present invention may be applied to any optical encoders having other known configurations. For example, the stationary slit part may be provided closer to the light receiving part than the rotational slit part. In this case, the light emitted from the light emitting part reaches the light receiving part after passing the rotational slit part and the stationary slit part in order.

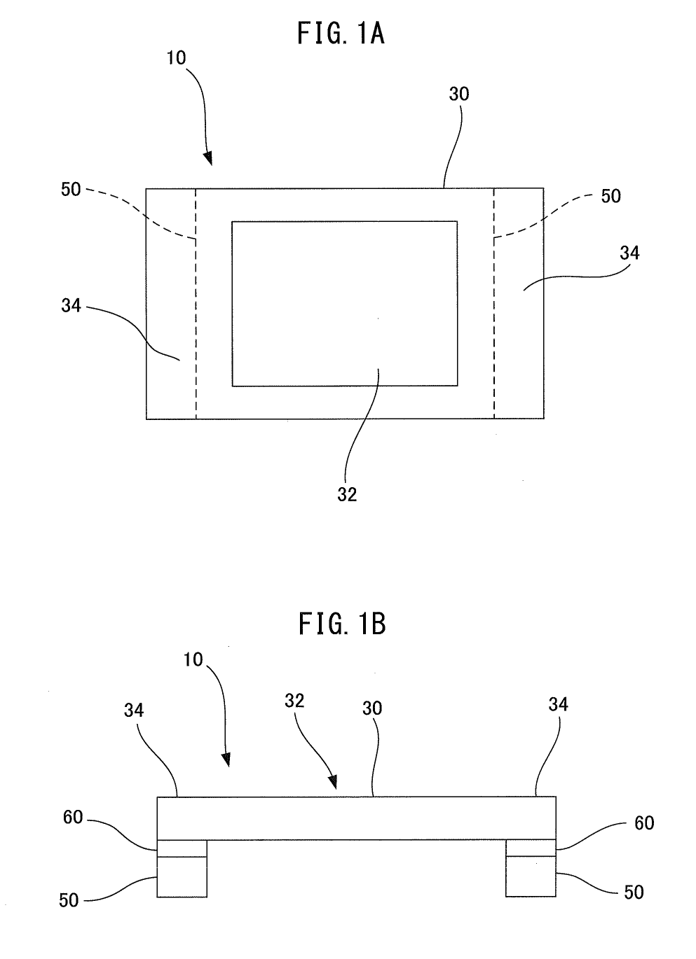

Referring to FIGS. 1A to 6B, detailed configurations of stationary slit parts of optical encoders according to various embodiments will be described. Redundant descriptions in relation to the respective embodiments will be omitted as necessary. The same or corresponding elements will be designated with the same referential numerals.

FIG. 1A is a top view illustrating a stationary slit part 10 of an optical encoder according to a first embodiment. FIG. 1B is a front view illustrating the stationary slit part 10 of FIG. 1A. The stationary slit part 10 includes a main body 30, a patterned portion 32 provided in the center of the main body 30, and fixed portions 34 provided on opposite edges of the main body 30.

The fixed portions 34 of the stationary slit part 10 are fixed to bases 50 by adhesive 60 as shown in FIG. 1B. This allows the stationary slit part 10 to be positioned on an optical axis line optically coupling the light emitting part and the light receiving part of the optical encoder, as described above with reference to FIG. 7. In FIG. 1A, contours of the bases 50 are depicted by dashed lines in order to show the positions of the bases 50.

Alternatively to the embodiment in which the adhesive 60 is used, the fixed portions 34 of the stationary slit part 10 may be fixed to the bases 50 by other known means. For example, the fixed portions 34 may be fixed to the bases 50 by screwing. Alternatively, a protrusion or a recess formed on the fixed portion 34 may be fitted to a corresponding recess or a protrusion formed on the base 50 in order to fix the fixed portion 34 to the base 50.

According to this embodiment, the stationary slit part 10 is made of resin. Resin used for the stationary slit part 10 may be polyehterimide (PEI), polyethersulfone (PES), or polycarbonate (PC). However, any other resin may be used as well, as long as the resin provides resistance to vibrating and impactive force sufficient to withstand vibrating or impactive force which may act on the stationary slit part 10. For example, the resin used for the stationary slit part 10 may have elasticity sufficient to absorb energy of vibration or impact.

The stationary slit part made of resin according to this embodiment withstands vibrating or impactive force which may directly or indirectly act on the stationary slit part. Therefore, reliability of the optical encoder can be improved. In addition, the stationary slit part made of resin is easy to handle during transportation, assembly or the like, and therefore, productivity can be improved. Further, since the stationary slit part made of resin is easy to form into a desired shape, a yield rate can be increased. Furthermore, since resin is inexpensive, the manufacturing cost can be reduced.

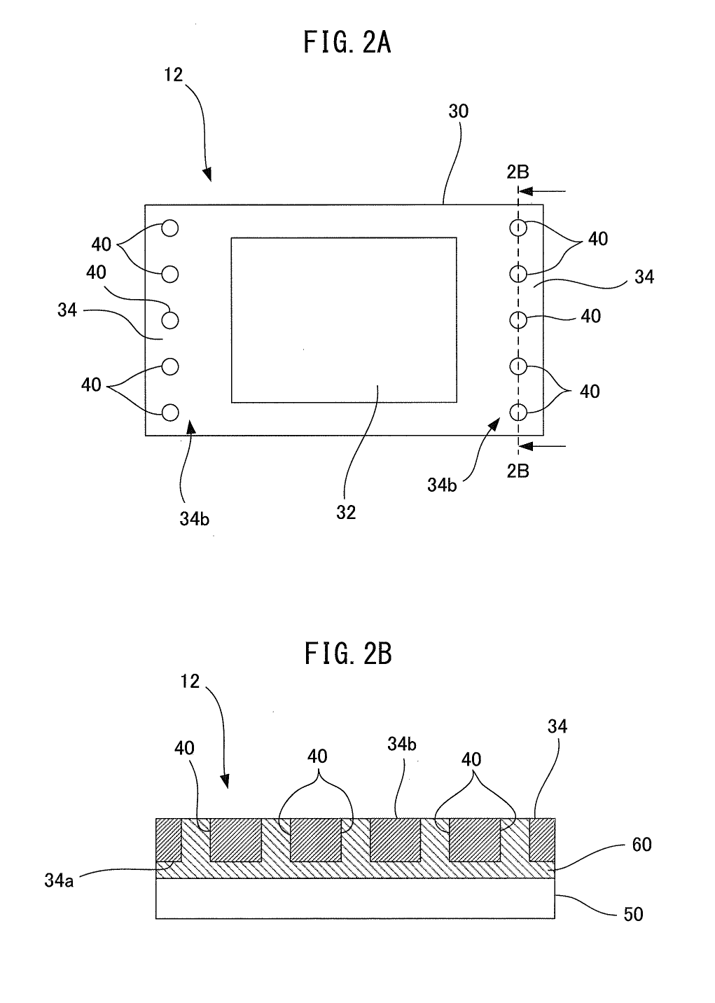

FIG. 2A is a top view illustrating a stationary slit part 12 of an optical encoder according to a second embodiment. FIG. 2B is a section view taken along dashed line 2B-2B of FIG. 2A. The stationary slit part 12 in this embodiment is made of resin similarly to the stationary slit part 10 of the above-described first embodiment. The fixed portions 34 of the stationary slit part 12 are formed with a plurality of through holes 40 spaced apart from each other. The through holes 40 extend between a back face 34a facing the base 50 and a front face 34b on an opposite side of the back face 34a.

According to this embodiment, as further illustrated in FIG. 2B, the respective through holes 40 are filled with adhesive 60. In this embodiment, contact area between the adhesive 60 and the stationary slit part 12 is increased, thereby increasing adhesive strength. Since the stationary slit part 12 can be tightly fixed to the base 50, the stationary slit part 12 can be prevented from being shifted on or sliding off the base 50 when vibrating or impactive force acts on the stationary slit part 12.

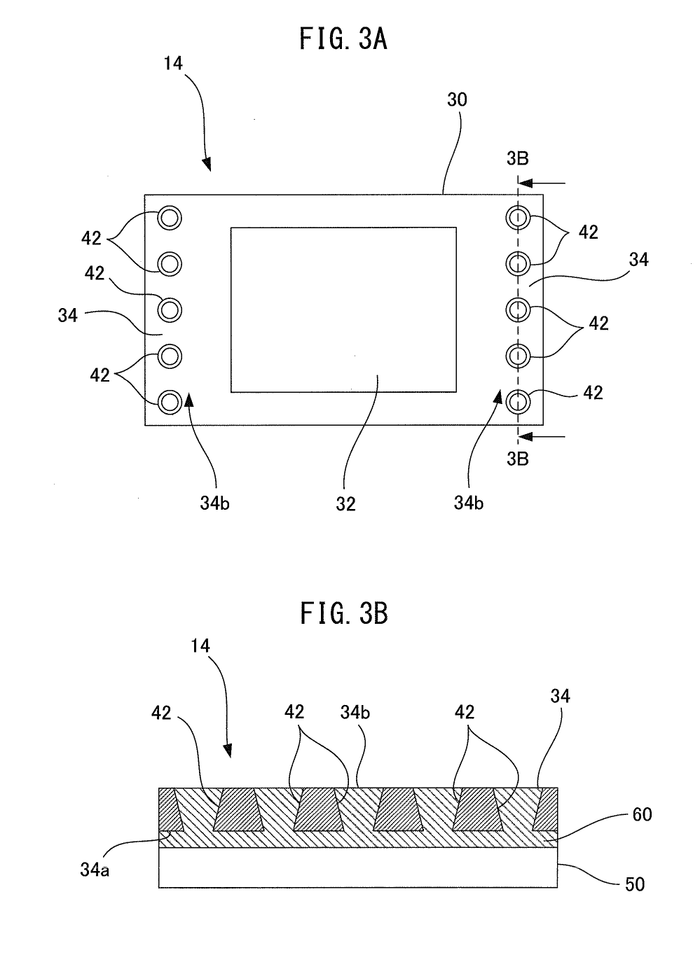

FIG. 3A is a top view illustrating a stationary slit part 14 of an optical encoder according to a third embodiment. FIG. 3B is a section view taken along dashed line 3B-3B of FIG. 3A. The stationary slit part 14 according to this embodiment is made of resin similarly to the stationary slit part 10 of the above-described first embodiment. The fixed portions 34 of the stationary slit part 14 are provided with through holes 42 spaced apart from each other similarly to the second embodiment described with reference to FIGS. 2A and 2B.

However, the through holes 42 in this embodiment are configured such that the cross-section area on a back face 34a facing the base 50 is different from the cross-section area on a front face 34b on an opposite side of the back face 34a. More specifically, the through holes 42 have a tapered circumference wall such that the cross-section area gradually decreases from the front face 34b to the back face 34a.

According to this embodiment, since contact area between the adhesive 60 and the stationary slit part 14 is increased, the adhesive strength is increased. The stationary slit part 14 is tightly fixed to the base 50, and therefore the stationary slit part 14 can be prevented from being shifted on or sliding off the base 50 when vibrating or impactive force acts on the stationary slit part 14.

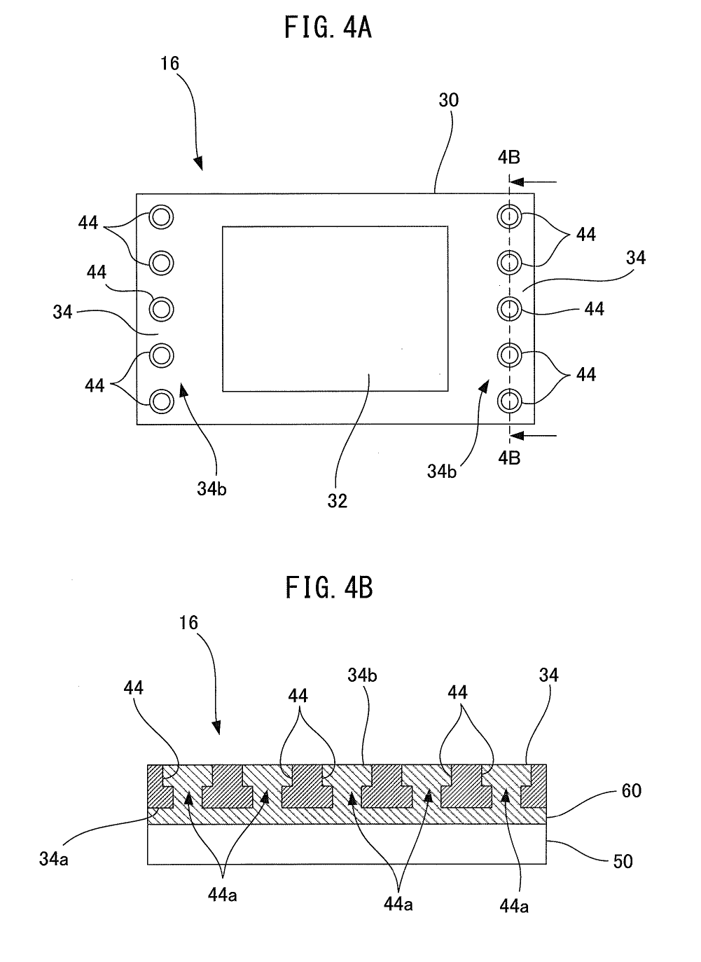

FIG. 4A is a top view illustrating a stationary slit part 16 of an optical encoder according to a fourth embodiment. FIG. 4B is a section view taken along dashed line 4B-4B of FIG. 4A. The stationary slit part 16 according to this embodiment is made of resin similarly to the stationary slit part 10 of the above-described first embodiment. The fixed portions 34 of the stationary slit part 16 are formed with through holes 44 spaced apart from each other similarly to the second embodiment described above with reference to FIGS. 2A and 2B.

However, the through holes 42 in this embodiment are configured such that the cross-section area on a back face 34a facing the base 50 is different from the cross-section area on a front face 34b on an opposite side of the back face 34a. More specifically, the through hole 42 has a stepped portion 44a between the front face 34b and the back face 34a, and the cross-section area of the through hole 44 is changed at the stepped portion. As a result, the cross-section of the through hole 44 is greater on the front face 34b than on the back face 34a.

According to this embodiment, since contact area between the adhesive 60 and the stationary slit part 16 is increased, the adhesive strength is increased. The stationary slit part 16 is tightly fixed to the base 50, and therefore the stationary slit part 16 can be prevented from being shifted on or sliding off the base 50 when vibrating or impactive force acts on the stationary slit part 16.

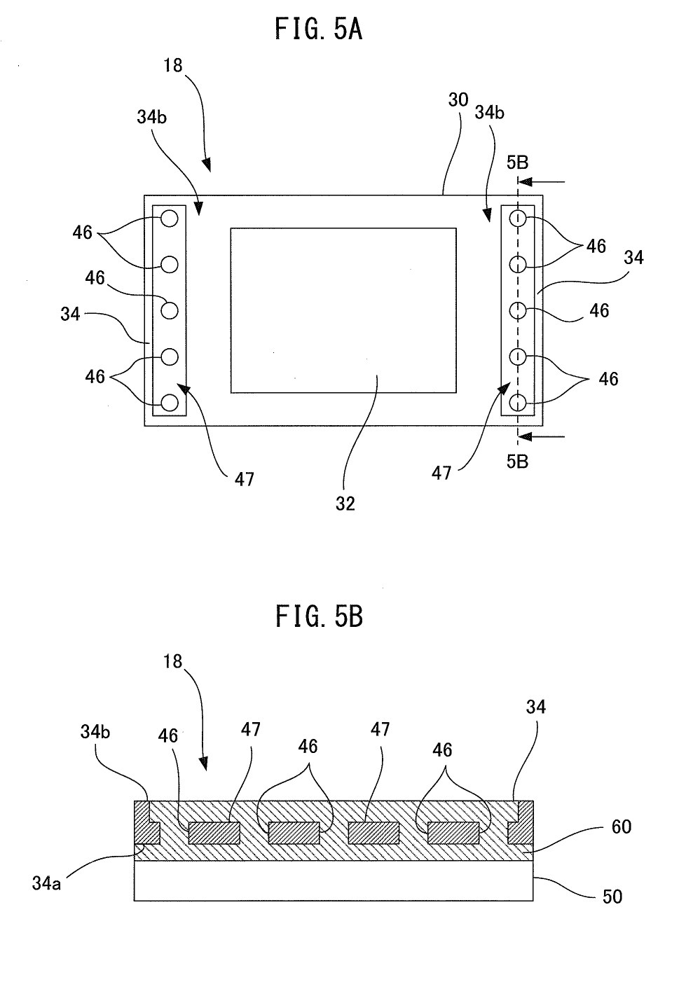

FIG. 5A is a top view illustrating a stationary slit part 18 of an optical encoder according to a fifth embodiment. FIG. 5B is a section view taken along dashed line 5B-5B of FIG. 5A. The stationary slit part 18 according to this embodiment is made of resin similarly to the stationary slit part 10 of the above-described first embodiment. The fixed portions 34 of the stationary slit part 18 are formed with through holes 46 spaced apart from each other similarly to the second embodiment described above with reference to FIGS. 2A and 2B.

However, according to this embodiment, a substantially rectangular recessed portion 47 is formed so as to surround the through hole 46. The recessed portion 47 is depressed from the front face 34b toward the back face 34a such that the recessed portion 47 and the respective through holes 46 are in communication with one another. Accordingly, the adhesive 60 used to fix the stationary slit part 18 to the base 50 is filled throughout the recessed portion 47 and the through holes 46.

According to this embodiment, since contact area between the adhesive 60 and the stationary slit part 18 is increased, the adhesive strength is increased. The stationary slit part 18 is tightly fixed to the base 50, and therefore the stationary slit part 18 can be prevented from being shifted on or sliding off the base 50 when vibrating or impactive force acts on the stationary slit part 18.

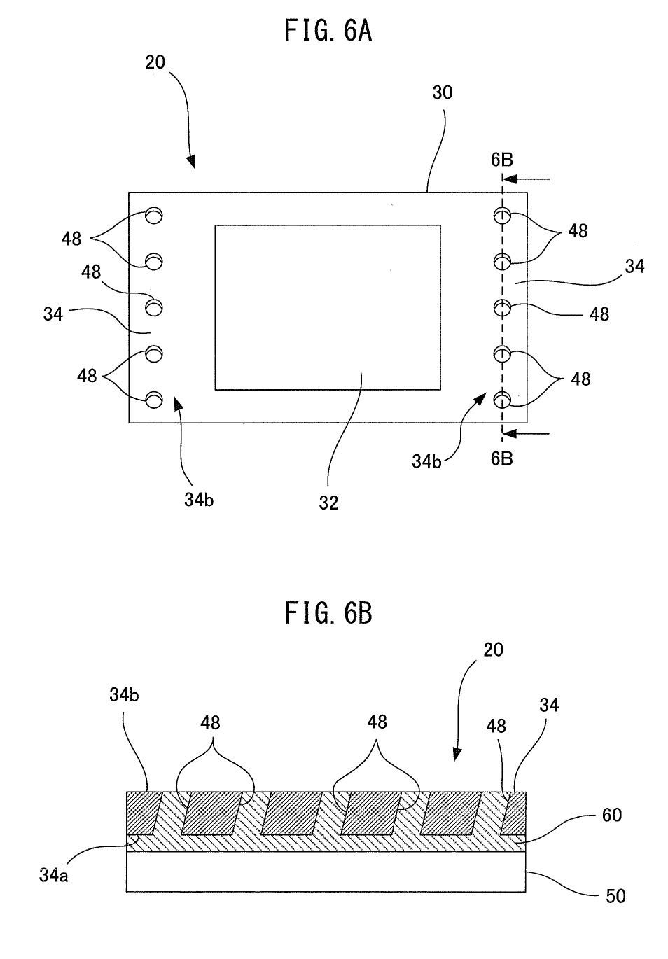

FIG. 6A is a top view illustrating a stationary slit part 20 of an optical encoder according to a sixth embodiment. FIG. 6B is a section view taken along dashed line 6B-6B of FIG. 6A. The stationary slit part 20 according to this embodiment is made of resin similarly to the stationary slit part 10 of the above-described first embodiment. The fixed portions 34 of the stationary slit part 20 are formed with through holes 48 spaced apart from each other similarly to the second embodiment described above with reference to FIGS. 2A and 2B.

However, the through holes 48 in this embodiment is slanted relative to a direction perpendicular to the back face 34a facing the base 50 and the front face 34b on an opposite side of the back face 34a.

According to this embodiment, since contact area between the adhesive 60 and the stationary slit part 20 is increased, the adhesive strength is increased. The stationary slit part 20 is tightly fixed to the base 50, and therefore the stationary slit part 20 can be prevented from being shifted on or sliding off the base 50 when vibrating or impactive force acts on the stationary slit part 20.

A stationary slit part of an optical encoder according to the present invention may have any other polygonal shapes, instead of the rectangular shape as illustrated. A contour of the stationary slit part may at least partly include a curved portion. For example, the stationary slit part may also have a smooth corner.

The number of through holes formed in the fixed portion of the stationary slit part is not limited to the illustrated example. Although the through holes are linearly arranged in the illustrated embodiment, the through holes are arranged in other manners.

### EFFECT OF THE INVENTION

According to the optical encoder configured as described above, the stationary slit part is made of resin, and therefore, the stationary slit part can be prevented from being damaged by vibrating or impactive force acting thereon. Accordingly, a highly reliable optical encoder can be provided. In addition, the stationary slit part made of resin facilitates handling such as transportation or assembly or the like, resulting in increased productivity. Further, using resin facilitates a shaping process for forming the stationary slit part into a desired shape, resulting in an increased yield rate. Furthermore, since resin is generally inexpensive, as compared to glass, the material cost can be reduced.

Although various embodiments and variants of the present invention have been described, it will be apparent to a person skilled in the art that the intended function and effect of the present invention can also be realized by other embodiments and variants. In particular, the constituent elements of the above-described embodiments and variants may be deleted or replaced, or a known means may be added, without departing from the scope of the present invention. Further, it will be apparent to a person skilled in the art that the present invention can also be implemented in any combination of features of a plurality of embodiments disclosed herein either explicitly or implicitly.

1. An optical encoder comprising:
a light emitting part for emitting light;
a stationary slit part and a rotational slit part which allow part of the light emitted from the light emitting part to pass therethrough; and
a light receiving part for detecting the light passing through the stationary slit part and the rotational slit part,
wherein the stationary slit part is made of resin.

2. The optical encoder according to claim 1, further comprising a support for supporting the stationary slit part,
wherein the stationary slit part is fixed to the support by adhesive.

3. The optical encoder according to claim 2, wherein the stationary slit part includes a through hole extending between a first face facing the support and a second face on an opposite side of the first face, and
wherein the stationary slit part is fixed to the support by adhesive filled within the through hole.

4. The optical encoder according to claim 3, wherein the through hole has cross-section area on the first face different from cross-section area on the second face.

5. The optical encoder according to claim 3, wherein the through hole is slanted relative to a direction perpendicular to the first face and the second face.
